(19) United States
(12) Patent Application Publication
(10) Pub. No.: US 2017/0284376 A1
(43) Pub. Date: Oct. 5, 2017

(54) Method and Control Device for Measuring a Load on a Rotor Blade of a Wind Power Plant

(71) Applicant: Robert Bosch GmbH, Stuttgart (DE)

(72) Inventors: Boris Buchtala, Muehlacker (DE); Felix Hess, Ludwigsburg (DE)

(21) Appl. No.: 15/510,453

(22) PCT Filed: Aug. 27, 2015
(86) PCT No.: PCT/EP2015/069604

§ 371 Date: Jun. 8, 2017

(30) Foreign Application Priority Data
Sep. 12, 2014 (DE) 10 2014 218 266.2

(51) Int. Cl. F03D 17/00; G01B 7/16; G01L 1/22

(52) U.S. Cl. CPC F03D 17/00; G01L 1/2268; G01B 7/16; F05B 2270/807; F05B 2270/808

(57) ABSTRACT

A method for measuring a load on a rotor blade of a wind power plant includes deriving a deflection of the rotor blade from an acceleration value, determining a signal drift component of the deflection by using an absolute value, and determining the load by using the signal drift component and the deflection and material characteristics of the rotor blade. The acceleration value represents an acceleration on the rotor blade, and the absolute value represents an absolute measured value from an absolute sensor on the rotor blade.

The present invention relates to a method for capturing a load on a rotor blade of a wind energy converter, to a corresponding control device, and to a corresponding computer program.

In the case of a wind energy converter, the wind causes deformation of the rotor blades, because of aerodynamic forces. To enable feedback control intervention to be made, it is necessary to capture this deformation.

Against this background, the approach proposed here presents a method for capturing a load on a rotor blade of a wind energy converter, furthermore a control device that uses this method, and finally a corresponding computer program, according to the main claims. Advantageous developments are given by the respective dependent claims and the description that follows.

The approach presented here enables the blade bend of rotor blades on a wind energy converter to be measured. Acceleration sensors are used for measuring. These measurements are referenced by a further absolute value measurement. Strain gauges or an optical measurement, for example, are used for this purpose.

In order for modern feedback control methods to be used, such as individual pitch control, reliable and inexpensive sensors are required. In the case of short-time field tests, this is not so important. Thus, although strain gauges are very suitable for load measurement, they do not achieve a service life of 20 years. Since there is a possibility of such as sensor sustaining a defect during the service life of the wind energy converter, reliable identification is important, in particular if the sensor is used for feedback control. The approach presented here proposes an improved sensor concept.

The core of the invention is to use inexpensive sensors for load measurement, and to identify faults by redundancy. Moreover, the combination of differing sensors enables better measurement results to be achieved. In addition, it is thus possible to use sensors that alone are not suitable for load measurement, and that permit load measurement only in combination. This also makes it possible, however, to use sensors that possibly have a much longer service life.

There is presented a method for capturing a load on a rotor blade of a wind energy converter, wherein the method has the following steps:

deriving a deflection of a rotor blade from an acceleration value, which represents an acceleration on the rotor blade;

determining a signal-drift component of the deflection by use of an absolute value, which represents an absolute measurement value of an absolute sensor on the rotor blade; and

calculating the load by use of the signal-drift component and the deflection and material characteristic values of the rotor blade.

A wind energy converter may be understood to be a wind power plant, or wind turbine. A rotor of the wind energy converter in this case is made to rotate by wind energy, and an electrical generator is driven by the rotor. A load may be a force on a rotor blade of the rotor. A deflection may be value a distance by which the rotor blade is forced out of a rest position by the load. A signal-drift component may be a base value by which a value of the deflection is shifted. The signal-drift component may change with time. The signal-drift component results from the derivation of the deflection from the acceleration. An absolute measurement value may be drift-free. A material characteristic value may be, for example, a flexural stiffness and/or a torsional stiffness.

The deflection may be compared with a strain value as an absolute value, in order to obtain the signal-drift component. The strain value may represent a strain of the rotor blade that can be captured by a strain gauge on the rotor blade. The strain is caused by the load. The strain is directly related to the load, via the material characteristic values. Strain gauges require a perfect connection to the rotor blade. Measurement of the strain is effected without drift.

The deflection may be compared with a position value as an absolute value, in order to obtain the signal-drift component. The position value may represent a position of the rotor blade that can be captured by a camera system on the rotor blade. The camera system may at least partly capture the rotor blade. The camera system may be disposed inside the rotor blade. The camera may have a fixed orientation. The rotor blade may move in an image of the camera, under the load. The camera may have a low resolution. The position measurement is likewise effected without drift.

The acceleration may be subjected to two-fold integration in order to obtain the deflection. The high sensitivity and robustness of the acceleration sensor can thereby be used to measure the deflected distance.

The signal-drift component may be deducted from the deflection, in order to obtain a stabilized deflection value for calculating the load. The deflection can thus be rendered drift-free.

The deflection and the absolute value may be compared by use of a Kalman filter, in order to determine the signal-drift component. The absolute value in this case may serve as a reference variable. The deflection is corrected to the reference variable. A correction amount is provided as a signal-drift component.

In the step of determining, the absolute value may additionally be subjected to plausibility checking, by using the deflection. If the absolute sensor has a fault, the fault can thus be found. Reliable functioning of the wind energy converter can thus be ensured.

The absolute value may be defined as erroneous if the absolute value deviates from the deflection by more than a tolerance range. A latitude can thus be provided in the identification of a sensor fault. Fluctuations resulting from changed environmental conditions are thus not taken into account.

The approach presented here additionally creates a control device that is designed to perform, control, or implement, in corresponding facilities, the steps of a variant of a method presented here. The object on which the invention is based can also be achieved in a rapid and efficient manner by this embodiment variant of the invention in the form of a control device.

A control device in the present case may be understood to mean an electrical device that processes sensor signals, and that outputs control and/or data signals in dependence thereon. The control device may have an interface, which may be realized as hardware and/or software. In the case of a realization as hardware, the interfaces may be, for example, part of a so-called system ASICs, which includes a great variety of functions of the control device. It is also possible, however, for the interfaces to be separate integrated circuits, or to be composed, at least partly, of discrete components. In the case of a realization as software, the interfaces may be software modules that are present, for example, on a microcontroller in addition to other software modules.

Also advantageous is a computer program product or computer program having program code that can be stored on a machine-readable carrier or storage medium, such as a solid-state memory, a hard-disk memory or an optical memory, and that is used for performing, implementing and/or controlling the steps of the method according to one of the embodiments described above, in particular when the program product or program is executed on a computer or a device.

The invention is explained exemplarily in greater detail in the following on the basis of the appended drawings. There are shown:

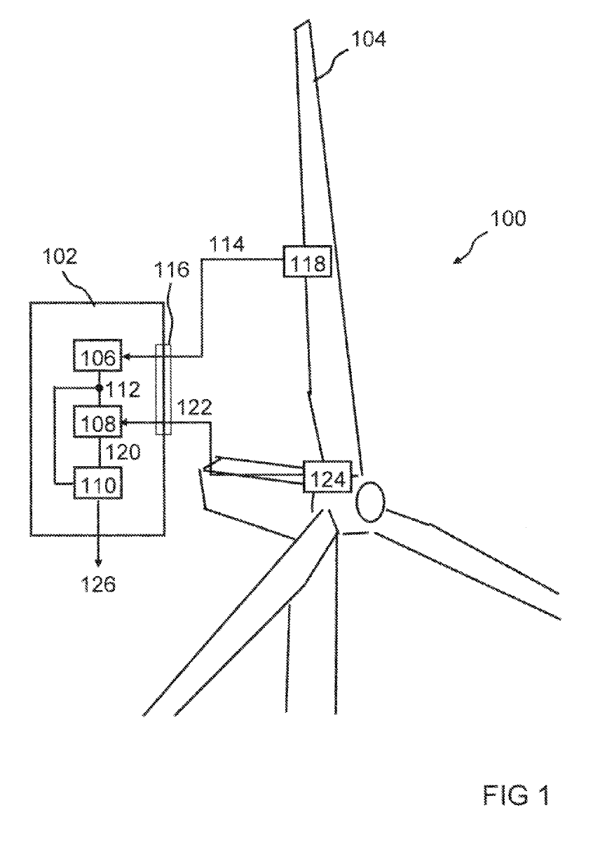

FIG. 1 a representation of a wind energy converter, having a device for capturing loads on rotor blades of the wind energy converter, according to an exemplary embodiment of the invention; and

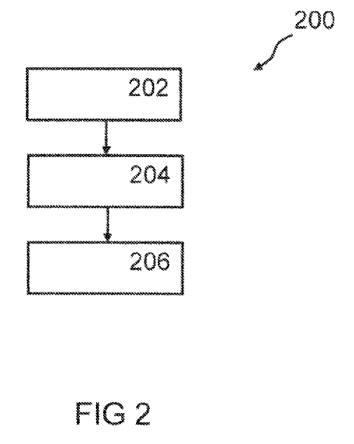

FIG. 2 a sequence diagram of a method for capturing a load on a rotor blade of a wind energy converter, according to an exemplary embodiment of the invention.

In the following figures, elements that are the same or similar may be denoted by the same or similar references. Moreover, the figures of the drawings, the description thereof and the claims contain numerous features in combination. To persons skilled in the art, it is obvious in this case that these features may also be considered singly, or they may be combined to form further combinations, not explicitly described here.

FIG. 1 shows a representation of a wind energy converter 100, having a control device 102 for capturing loads on rotor blades 104 of the wind energy converter 100, according to an exemplary embodiment of the invention. The control device 102 has a means 106 for derivation, a means 108 for determination, and a means 110 for calculation. The control device may be disposed, for example, in the nacelle of the wind energy converter 100.

The wind energy converter 100 has an acceleration sensor 118. The acceleration sensor 118 is connected to the rotor blade 104. Here, the acceleration sensor 118 is positioned approximately in the middle of the rotor blade 104. The acceleration sensor 118 may also be positioned further in the direction of a blade tip of the rotor blade 104, since the acceleration of the rotor blade 104 that can be captured increases toward the blade tip. The acceleration sensor 118 is designed to provide an acceleration value 114 that represents an acceleration on the rotor blade 104.

The means 106 for derivation is designed to derive a deflection 112 of a rotor blade 104 from the acceleration value 114. For this purpose, the acceleration value 114 is read-in by an acceleration sensor 118 via an interface 116 of the control device 102. According to this exemplary embodiment, the acceleration value 114 is integrated in order to obtain the deflection 112.

The means 108 for determination is designed to determine a signal-drift component 120 of the deflection 112 by use of an absolute value 122. The absolute value 122 represents an absolute measurement value of an absolute sensor 124 on the rotor blade 104. The absolute measurement value has no signal-drift component. The absolute value 122 is read-in by the absolute sensor 124 via the interface 116. The deflection 112 and the absolute value 122 are compared using a Kalman filter, in order to determine the signal-drift component 120.

The means 110 for calculation is designed to calculate a load on the rotor blade 104, by use of the signal-drift component 120 and the deflection 112 and material characteristic values of the rotor blade 104, and to map this in a load value 126 representing the load. The signal-drift component 120 in this case is deducted from the deflection 112, in order to obtain a stabilized deflection value for calculating the load. The load is obtained from a load characteristic line of the rotor blade 104. The load characteristic line describes a relationship between the actual deflection 112 of the rotor blade and the load on the rotor blade 104.

In one exemplary embodiment, the absolute value 122 is a strain value 122, which is compared with the deflection 112 in order to obtain the signal-drift component 120. The strain value 122 represents a strain of the rotor blade 104 that is captured by a strain gauge 124 on the rotor blade 104. The strain gauge 124 or the strain gauges 124 are mounted on a blade root of the rotor blade 104, since here the strain is maximal.

In another exemplary embodiment, the absolute value 122 is a position value 122, which is compared with the deflection 112 in order to obtain the signal-drift component 120. The position value 122 represents a position of the rotor blade 104 captured by a camera system 124 on the rotor blade 104. The camera system 124 optically captures, as features, the rotor blade 104, parts of the rotor blade 104 and/or particular features on or in the rotor blade 104. The position of the rotor blade 104 is determined from coordinates of image points at which the features are mapped. The capture accuracy of the camera system 124 ensues from an angular resolution per image point.

In the case of wind energy converters 100 that have a horizontal axis and three rotor blades 104, the rotational speed above the nominal wind speed is controlled, by synchronous adjustment of the blade angles, such that, owing to the change in the angle of attack, the aerodynamic lift, and consequently the driving torque, is altered in such a manner that the wind energy converter 100 can be kept in the range of the nominal rotational speed. In the case of wind speeds above the cut-out wind speed, this pitch control mechanism is additionally used as a brake, in that the blades 104 are set with the nose into the wind, such that the rotor no longer delivers any significant driving torques.

In the case of this collective pitch control, asymmetric aerodynamic loads result in pitch and yaw moments on the nacelle. The asymmetric loads are produced, for example, as a result of wind shears in the vertical direction (boundary layers), yaw angle errors, gusts and turbulences, build-up of the flow at the tower, etc. These asymmetric aerodynamic loads can be reduced by individually adjusting the angle of attack of the blades 104 (individual pitch control, IPC). The sensors 124 in this case are mounted in or on the rotor blades 104, in order to measure the impact bending moments. The latter can then serve as controlled variables for individual pitch control.

For condition monitoring of rotor blades 104, acceleration sensors 118 in the blades 104 are used. Natural frequencies of the rotor blade 104 can thereby be measured. Damage to the rotor blade 104 can be detected, since the natural frequencies then shift. It is not possible to measure load only with acceleration sensors 118, since only accelerations, but not the blade loads, are measured.

The approach presented here describes an improved condition monitoring. Captured in this case are items of information 114, 122 relating to the loads to which a rotor blade 104 is subjected.

For condition monitoring, acceleration sensors 118 are used in rotor blades 104. These sensors alone are unsuitable for load measurement, since the sensor signal 114 has to be subjected to two-fold integration in order to calculate the blade deflection at the location of the sensor 118. Such a two-fold integration, however, has a time drift 120, which results in the output value 112 no longer corresponding to the actual blade deflection, even after a short time. In the case of the approach presented here, the sensor signal 112 of the acceleration sensor 118 is freed from the drift 120, thereby enabling the high resolution of the acceleration sensor 118 to be exploited.

In one exemplary embodiment, the acceleration sensor 118 is combined with a strain gauge 124. The strain gauge 124 is mounted on the blade root, and captures the blade load. In the control device 102, it is checked whether the measured strain 122 and the values 112 calculated from the acceleration measurement match each other. This correlation may be performed by an observer, for example a Kalman filter. If it is found that the measured sensor values do not match each other, the IPC can be deactivated, and a message to replace the sensor 118, 124 can be transmitted. In this exemplary embodiment, the measurements are not used primarily to prolong the service life, but for reliable fault identification.

In one exemplary embodiment, the acceleration sensor 118 is combined with a camera-based deflection sensor system 124. The acceleration sensor 118 in this case is combined with a camera-based measurement of the deflection. In this case, a camera 124 is mounted at the blade root of the rotor blade 104. This camera looks into the inside of the rotor blade 104. The displacement of markers mounted in the rotor blade 104 is measured by the camera 124. The markers may be reflective, and reflect light emitted by the camera 124, or they themselves may illuminate actively, for example by means of LEDs or the light conducted by glass fibers.

In the case of the approach presented here, an inexpensive, low-resolution camera 124 may be used. The measuring resolution in this case is not sufficiently great to capture the load on the rotor blade 104 only by use of the camera 124. In combination with an acceleration sensor 118 in the rotor blades 104, however, the required measuring accuracy can be achieved by the fusion of the sensor data in a Kalman filter, presented here.

The system presented here enables the blade deflection, or another, equivalent quantity, such as the blade-root bending moment, to be measured. The measurement in this case is based on a combination of differing sensors 118, 124.

The approach presented here enables blade-root bending moments to be measured in an inexpensive manner, and with a long service life. A combination of a plurality of sensors can be used for the measurement task described.

FIG. 2 shows a flow diagram of a method 200 for capturing a load on a rotor blade of a wind energy converter according to an exemplary embodiment of the invention. The method 200 has a step 202 of deriving, a step 204 of determining and a step 206 of calculating. In the step 202 of deriving, a deflection of the rotor blade is derived from an acceleration value. The acceleration value represents an acceleration on the rotor blade. In the step 204 of determining, a signal-drift component of the deflection is determined, by use of an absolute value. The absolute value represents an absolute measurement value of an absolute sensor on the rotor blade. In the step 206 of calculating, the load is calculated by use of the signal-drift component and the deflection and material characteristic quantities of the rotor blade.

In one exemplary embodiment, in the step 204 of determining, the absolute value is additionally subjected to plausibility checking, by using the deflection. In this case, the absolute value is defined as erroneous if the absolute value deviates from the deflection by more than a tolerance range.

In other words, the approach presented here describes a combination of sensors for measuring rotor blade loads.

The exemplary embodiments shown have been selected merely as examples, and may be combined with each other.

### LIST OF REFERENCES

100 wind energy converter

102 control device

104 rotor blade

106 means for derivation

108 means for determination

110 means for calculation

112 deflection

114 acceleration value

116 interface

118 acceleration sensor

120 signal-drift component

122 absolute value

124 absolute sensor

126 load value

200 method for capturing a load

202 step of deriving

204 step of determining

206 step of calculating

1. A method for capturing a load on a rotor blade of a wind energy converter, comprising:
deriving a deflection of a rotor blade from an acceleration value indicative of an acceleration on the rotor blade;
determining a signal-drift component of the deflection using an absolute value indicative of an absolute measurement value of an absolute sensor on the rotor blade; and
calculating a load on the rotor blade using the signal-drift component and the deflection, and material characteristic values of the rotor blade.

2. The method as claimed in claim 1, wherein:
the determining includes comparing the deflection a strain value as an absolute value to obtain the signal-drift component, and
the strain value is indicative of a strain of the rotor blade that can be captured by a strain gauge on the rotor blade.

3. The method as claimed in claim 1, wherein:
the determining includes comparing the deflection with a position value as an absolute value to obtain the signal-drift component and
the position value is indicative of a position of the rotor blade that can be captured by a camera system on the rotor blade.

4. The method as claimed in claim 1, wherein the deriving includes performing two-fold integration on the acceleration value to obtain the deflection.

5. The method as claimed in claim 1, wherein the calculating includes deducting the signal-drift component is deducted from the deflection, in order to obtain a stabilized deflection value for calculating the load.

6. The method as claimed in claim 1, wherein the determining includes comparing the deflection and the absolute value using a Kalman filter to determine the signal-drift component.

7. The method as claimed in claim 1, wherein the determining includes performing a plausibility check on the absolute value using the deflection.

8. The method as claimed in claim 7, wherein the determining includes defining the absolute value as erroneous in response to a deviation of the absolute value from the deflection by more than a tolerance range.

9. A control device for capturing a load on a rotor blade of a wind energy converter, the control device configured to:
derive a deflection of a rotor blade from an acceleration value indicative of an acceleration of the rotor blade;
determine a signal-drift component of the deflection using an absolute value indicative of an absolute measurement value of an absolute sensor on the rotor blade; and
calculate a load on the rotor blade using the signal-drift component, the deflection, and material characteristic values of the rotor blade.

10. A computer program, that, when executed by a processor of a computing device, causes the computing device to to perform the following acts:
deriving a deflection of a rotor blade from an acceleration value indicative of an acceleration of the rotor blade;
determining a signal-drift component of the deflection using an absolute value indicative of an absolute measurement value of an absolute sensor on the rotor blade; and
calculating a load on the rotor blade using the signal-drift component, the deflection, and material characteristic values of the rotor blade.
